(19) United States
(12) Patent Application Publication
(10) Pub. No.: US 2026/0346420 A1
(43) Pub. Date: Nov. 5, 2026

(54) POWER TOOL WITH LOW-PROFILE GEARCASE

(71) Applicant: Black & Decker Inc., New Britain, CT (US)

(72) Inventors: Dennis A. BUSH, Blue Springs, MO (US); Joseph P. KELLEHER, Parkville, MD (US); Lukas PURASSON, Baltimore, MD (US); Heather SCHAFER, Myrtle Beach, SC (US)

(21) Appl. No.: 19/650,222

(22) Filed: Apr. 16, 2026

Related U.S. Application Data
(60) Provisional application No. 63/797,845, filed on Apr. 30, 2025.

(51) Int. Cl. B25F 5/00; B25F 5/02; F21V 33/00; F21Y 115/10

(52) U.S. Cl. CPC B25F 5/001; B25F 5/02; F21V 33/0084; F21Y 2115/10

(57) ABSTRACT

A power tool can have a tool housing, a motor, a transmission assembly, a low-profile gearcase attached to the tool housing, and a pinion assembly at least partially inside the gearcase configured to transmit torque between the transmission assembly and an output shaft. The motor can be at least partially received in the housing and have a rotor shaft rotatable about a motor axis. The transmission assembly can be configured to transmit torque from the rotor shaft to the output shaft attached to and rotatable with a tool holder. The output shaft and tool holder can be rotatable about a output axis transverse to the motor axis. The pinion assembly can have a long shaft supported by at least two bearings separated by a spacer. The shape of the low-profile gearcase gives the power tool improved accessibility to tight or cramped workspaces.

### CROSS-REFERENCE TO RELATED APPLICATION

The present application claims priority to and the benefit of U.S. Provisional Patent Application No. 63/797,845, filed on Apr. 30, 2025, titled Power Tool with Low-Profile Gearcase.

### INCORPORATION BY REFERENCE

The disclosure of U.S. Provisional Patent Application No. 63/797,845, filed on Apr. 30, 2025, titled Power Tool with Low-Profile Gearcase, is hereby incorporated by reference for all purposes as if set forth in its entirety.

### TECHNICAL FIELD

The present application relates to power tools, and more specifically to power tools with improved low-profile gearcases.

### BACKGROUND

Power tools can be used in a wide variety of applications, for example, in commercial or home construction, home improvement projects, craft hobbies, and others, to name a few. In order to provide effective access to a wide variety of work surfaces and job locations, it is desirable for a power tool to be ergonomic with a compact, low-profile tool head. This is especially true in applications involving work in tight or cramped locations. Some tool configurations may be limited in torque output or involve large, bulky transmissions at the tool head or working end of the tool that can inhibit access to tight or cramped workspaces. There is therefore a need for a power tool having improved construction and performance.

### SUMMARY

An aspect of the present disclosure is directed to a power tool including a power tool housing extending at least partially around an interior of the tool housing, a motor at least partially received in the interior of the tool housing, a rotor shaft extending from the motor along a motor axis of the power tool such that the motor is configured to apply a first torque to the rotor shaft, a transmission assembly comprising at least one planetary gearset mechanically coupled to the rotor shaft for producing a gear reduction on the rotor shaft at the first torque, a pinion assembly comprising a pinion shaft mechanically coupled to the at least one planetary gearset for rotation about the motor axis, a gearcase coupled to the tool housing and extending at least partially around a gearcase chamber, an output shaft at least partially received in the gearcase chamber and arranged for being driven by the pinion shaft along an output axis, and a tool holder at least partially receiving the output shaft. The pinion shaft can receive a second torque from the at least one planetary gearset when the motor is activated such that the second torque greater than the first torque. The output axis can be perpendicular to the motor axis. The pinion shaft can have a length along the motor axis between approximately 50 mm and approximately 60 mm.

Implementations of this aspect may include one or more of the following features.

According to some example implementations, the pinion assembly can further comprise a pinion bearing mounted to a front portion of the pinion shaft and radially positioned between a portion of the gearcase and a portion of the pinion shaft. The pinion shaft can be oriented along the motor axis such that an axially rearward direction is toward the motor and such that an axially forward direction is toward the gearcase. The pinion bearing can be a front pinion bearing, and the pinion assembly can further comprise a rear pinion bearing mounted to the pinion shaft radially between the gearcase and the pinion shaft. The rear pinion bearing can be disposed axially rearward of the front pinion bearing along the motor axis.

According to some example implementations, the pinion assembly can further comprise a spacer radially positioned between the pinion shaft and the gearcase, the spacer arranged axially between the front pinion bearing and the rear pinion bearing along the motor axis. The front pinion bearing, the rear pinion bearing, and the spacer can be positioned in the gearcase chamber axially forward of the tool housing along the motor axis. The pinion assembly can further comprise a bevel gear in mechanical communication with the pinion shaft and positioned axially forward of the front pinion bearing along the motor axis. The bevel gear can be intermeshed with an output gear mechanically coupled to the output shaft.

According to some example implementations, the at least one planetary gearset is arranged to form a central bore at least partially receiving a portion of the pinion shaft therethrough. The at least one planetary gearset can comprise a sun gear mechanically coupled to the rotor shaft, a plurality of planet gears intermeshed with the sun gear, the plurality of planet gears coupled to a planet carrier, and a ring gear surrounding and intermeshed with the plurality of planet gears. The pinion shaft can be coupled to the planet carrier for rotation therewith. The pinion shaft can be oriented along the motor axis such that an axially rearward direction is toward the motor and such that an axially forward direction is toward the gearcase, and at least the sun gear, the plurality of planet gears, and the ring gear are axially rearward of the gearcase. The transmission assembly can further comprise a spindle lock assembly configured to permit the pinion shaft to be rotatably driven by the transmission assembly and inhibit rotation of the pinion shaft when the pinion shaft is rotated manually.

According to some example implementations, the at least one planetary gearset is a first planetary gearset, the sun gear is a first sun gear, the plurality of planet gears are a plurality of first planet gears, the ring gear is a first ring gear, and the planet carrier is a first planet carrier. The transmission assembly can further comprise a second planetary gearset mechanically coupled to the first planetary gearset, the second planetary gearset comprising a second sun gear, a plurality of second planet gears intermeshed with the second sun gear, a second planet carrier coupled to the plurality of second planet gears, and a second ring gear surrounding and intermeshed with the plurality of second planet gears.

According to some example implementations, the pinion shaft can be mechanically coupled to the second planet carrier for rotation therewith. The pinion shaft can have a front portion with a first diameter and a rear portion with a second diameter greater than the first diameter. The pinion shaft can have a length along the motor axis of approximately 55 mm.

According to some example implementations, the gearcase can have a top end, a bottom end, and a height along the output axis from the top end to the bottom end that is less than 35 mm. According to some embodiments, the height of the gearcase is approximately 26 mm.

According to some example implementations, the power tool can further comprise a trigger assembly for energizing the motor and comprising an inner member at least partially received in an outer member, the outer member and inner member fixed and rotatable about a central pivot. The trigger assembly can be engageable at a first portion of the outer member and a second portion of the outer member to pivot the trigger assembly about the central pivot and energize the motor.

According to some example implementations, the power tool can further comprise an illumination device mounted to the gearcase and coaxially arranged with the tool holder. The illumination device can further comprise a ring cover supporting a plurality of light emitting diodes (LEDs).

Another aspect of the present disclosure is generally directed to a power tool having a tool housing extending at least partially around an interior of the tool housing, a motor, a pinion shaft coupled to the motor for being rotatably driven by the motor about a motor axis, a transmission assembly at least partially received in the housing and configured to transmit torque about the motor axis from a motor to the pinion shaft, an output shaft rotatably driven by the pinion shaft and rotatable about an output axis transverse to the motor axis, a tapered gearcase coupled to a front end portion of the housing and extending at least partially around a gearcase chamber, and a tool holder at least partially receiving the output shaft. The pinion shaft can be at least partially received in the gearcase chamber. The tapered gearcase can have a top end, a bottom end, and a height along the output axis from the top end to the bottom end that is less than 35 mm.

The transmission assembly can comprise a sun gear driven by the motor, a plurality of planet gears intermeshed with the sun gear, the plurality of planet gears coupled to a planet carrier, and a ring gear surrounding the plurality of planet gears. The pinion shaft can be coupled to the planet carrier for rotation therewith.

According to some example implementations, the power tool can further comprise a trigger assembly for energizing the motor and comprising an inner member at least partially received in an outer member, the outer member and inner member fixed and rotatable about a central pivot. The trigger assembly can be engageable at a first portion of the outer member and a second portion of the outer member to pivot the trigger assembly about the central pivot and energize the motor.

According to some example implementations, the power tool can further comprise an illumination device mounted to the gearcase and coaxially arranged with the tool holder. The illumination device can further comprise a ring cover supporting a plurality of light emitting diodes (LEDs).

Implementations of this aspect may include one or more of the following features.

According to some example implementations, the pinion shaft has a length along the motor axis between approximately 50 mm and approximately 60 mm. The power tool can also include a pinion bearing mounted to a front portion of the pinion shaft and radially positioned between a portion of the gearcase and a portion of the pinion shaft. The pinion shaft can be oriented along the motor axis such that an axially rearward direction is toward the motor and such that an axially forward direction is toward the gearcase. The pinion bearing can be a front pinion bearing, and the pinion assembly can further comprise a rear pinion bearing mounted to the pinion shaft radially between the gearcase and the pinion shaft. The rear pinion bearing can be disposed axially rearward of the front pinion bearing along the motor axis.

Another aspect of the present disclosure is generally directed to a power tool having a tool housing extending at least partially around an interior of the tool housing, a motor at least partially received in the tool housing and configured to be energized to produce a rotational output about a motor axis, a transmission assembly for transmitting rotational motion from the motor to an output shaft and at least partially received in the tool housing, a gearcase coupled to the tool housing and extending at least partially around a gearcase chamber, a pinion assembly at least partially received in the gearcase chamber and comprising a pinion shaft rotatable about the motor axis, a first bevel gear coupled to a distal portion of the pinion shaft and rotatable about the motor axis, and an output shaft coupled to a second bevel gear and a tool holder. The second bevel gear can be intermeshed with the first bevel gear such that output shaft is configured to rotate about an output axis transverse to the motor axis upon energization of the motor. At least a portion of the output shaft can extend above the first bevel gear.

The pinion assembly can also include a spacer arranged about a portion of the pinion shaft, a front pinion bearing coupled with the pinion shaft axially forward of the spacer, and a rear pinion bearing coupled with the pinion shaft axially rearward of the spacer.

Implementations of this aspect may include one or more of the following features.

According to some example implementations, the gearcase can have a top end, a bottom end, and a height along the output axis from the top end to the bottom end that is less than 35 mm. The pinion shaft can have a length along the motor axis between approximately 50 mm and approximately 60 mm. The transmission assembly can further include a spindle lock assembly that is configured to permit the pinion shaft to be rotatably driven by the transmission assembly and inhibit rotation of the pinion shaft when the pinion shaft is rotated manually.

According to some example implementations, the power tool can further comprise a trigger assembly for energizing the motor and comprising an inner member at least partially received in an outer member, the outer member and inner member fixed and rotatable about a central pivot. The trigger assembly can be engageable at a first portion of the outer member and a second portion of the outer member to pivot the trigger assembly about the central pivot and energize the motor.

According to some example implementations, the power tool can further comprise an illumination device mounted to the gearcase and coaxially arranged with the tool holder. The illumination device can further comprise a ring cover supporting a plurality of light emitting diodes (LEDs).

Another aspect of the present disclosure is generally directed to a power tool comprising a tool housing extending at least partially around an interior of the tool housing, a motor, a pinion shaft coupled to the motor for being rotationally driven by the motor about a motor axis, a transmission assembly at least partially received in the housing and configured to transmit torque about the motor axis from the motor to the pinion shaft, an output shaft rotatably driven by the pinion shaft and rotatable about an output axis generally transverse to the motor axis, a tapered gearcase coupled to a front end portion of the housing and extending at least partially around a gearcase chamber, and a tool holder at least partially receiving the output shaft.

The transmission assembly can include a sun gear driven by the motor, a plurality of planet gears intermeshed with the sun gear, the plurality of planet gears coupled to a planet carrier, and a ring gear surrounding the plurality of planet gears, the pinion shaft coupled to the planet carrier for rotation therewith. The pinion shaft can be at least partially received in the gearcase chamber. The tapered gearcase can have a top end, and a height along the output axis from the top end to a bottom of the tool holder is less than approximately 80 mm.

Implementations of this aspect may include one or more of the following features.

According to some example implementations, the power tool is a drill, and the pinion shaft has a length along the motor axis between approximately 50 mm and approximately 60 mm.

According to some example implementations, the power tool can also comprise a trigger assembly for energizing the motor including an inner member at least partially received in an outer member, the outer member and inner member fixed and rotatable about a central pivot. The trigger assembly can be engageable at a first portion of the outer member and a second portion of the outer member to pivot the trigger assembly about the central pivot and energize the motor.

According to some example implementations, the power tool can further comprise an illumination device mounted to the gearcase and coaxially arranged with the tool holder. The illumination device can further comprise a ring cover supporting a plurality of light emitting diodes (LEDs).

Another aspect of the present disclosure is generally directed to a drill comprising a tool housing extending at least partially around an interior of the tool housing, a motor at least partially received in the interior of the tool housing and comprising a motor axis, a transmission assembly comprising at least one planetary gearset mechanically coupled to the motor configured to produce a gear reduction, a pinion assembly comprising a pinion shaft mechanically coupled to the at least one planetary gearset for rotation about the motor axis, a gearcase coupled to the tool housing and extending at least partially around a gearcase chamber, an output shaft at least partially received in the gearcase chamber and arranged for being rotatably driven by the pinion shaft along an output axis, and a tool holder rotatably driven by the output shaft and comprising a chuck having a plurality of clamping jaws for releasably retaining the shank of a tool bit. The output axis can be perpendicular to the motor axis. The pinion shaft can receive a torque from the at least one planetary gearset when the motor is activated, and the pinion shaft can have a length along the motor axis between approximately 50 mm and approximately 60 mm.

Implementations of this aspect may include one or more of the following features.

According to some example implementations, the at least one planetary gearset of the drill is arranged to form a central bore at least partially receiving a portion of the pinion shaft therethrough. The transmission assembly can further comprise a spindle lock assembly configured to permit the pinion shaft to be rotatably driven by the transmission assembly and inhibit rotation of the pinion shaft when the pinion shaft is rotated manually.

According to some example implementations, the gearcase of the drill can have a top end, a bottom end, and a height along the output axis from the top end to the bottom end that is less than approximately 35 mm. The height of the gearcase can be approximately 26 mm.

According to some example implementations, the drill can further comprise a trigger assembly for energizing the motor, the trigger assembly comprising an inner member at least partially received in an outer member, the outer member and inner member fixed and rotatable about a central pivot. The trigger assembly can be engageable at a first portion of the outer member and a second portion of the outer member so as to pivot the trigger assembly about the central pivot and energize the motor.

According to some example implementations, the drill can further comprise an illumination device mounted to the gearcase and coaxially arranged with the tool holder. The illumination device can further comprise a ring cover supporting a plurality of light emitting diodes (LEDs).

Those skilled in the art will appreciate the above stated advantages and other advantages and benefits of various additional embodiments reading the following detailed description of the embodiments with reference to the below-listed drawing figures.

### BRIEF DESCRIPTION OF THE DRAWINGS

According to common practice, the various features of the drawings discussed below are for illustrative purposes and are not necessarily drawn to scale. Some dimensions of various features and elements in the drawings may be expanded or reduced to more clearly illustrate the embodiments of the disclosure.

FIG. 1 is a first, left side isometric view of a power tool according to an example embodiment of the disclosure.

FIG. 2 is a right side elevation view of the power tool of FIG. 1.

FIG. 3 is an exploded view of a power tool of FIG. 1 according to an example embodiment of the disclosure.

FIG. 4 is a side cross-section of a power tool of FIG. 1 according to an example embodiment of the disclosure.

FIG. 5 is an enlarged view of detail area ‘A’ identified in FIG. 4 showing components of the transmission assembly of the power tool.

FIG. 6A is a view of the spindle lock assembly of the power tool from FIG. 4 with housing and transmission assembly components removed for clarity of illustration.

FIG. 6B is a plan view of the spindle lock assembly from FIG. 4 viewed in an axially forward direction.

FIG. 7 is an enlarged view of detail area ‘B’ identified in FIG. 4 showing components of the gearcase, pinion assembly, and tool holder of the power tool.

FIG. 8 is an exploded view of selected components seen in the area of detail ‘B’ showing components on the output axis of the power tool from FIG. 4 according to an example embodiment of the disclosure.

FIG. 9 is an exploded view showing components of a pinion assembly of the power tool of FIG. 1 according to an example embodiment of the disclosure.

FIG. 10 is an exploded view of the pinion assembly and gearcase of the power tool of FIG. 1 according to an example embodiment of the disclosure.

FIG. 11 is a view of the power tool of FIG. 1 accessing a cramped or tight workspace according to an example embodiment of the disclosure.

FIG. 12 shows dimensional characteristics of the gearcase of the power tool of FIG. 1 according to an example embodiment of the disclosure.

FIG. 13 is a cross-sectional view of a dual-pivot trigger assembly of the power tool of FIG. 1 according to an example embodiment of the disclosure.

FIG. 14 is an exploded view showing select components of the trigger assembly of FIG. 13.

FIG. 15A is a cross-sectional view of the trigger assembly of FIG. 13 showing the trigger assembly rotated counterclockwise about a central pivot.

FIG. 15B is a cross-sectional view of the trigger assembly of FIG. 13 showing the trigger assembly rotated clockwise about the central pivot.

FIG. 16A is a side profile view of an illumination device for a power tool according to an example embodiment of the disclosure.

FIG. 16B is a plan view of the illumination device of FIG. 16A.

FIG. 17 is an exploded view of the illumination device of FIG. 16A.

FIG. 18 is a view of a power tool using the illumination device in a workspace according to an example embodiment of the disclosure.

Corresponding parts are designated by corresponding reference numbers throughout the drawings.

### DETAILED DESCRIPTION

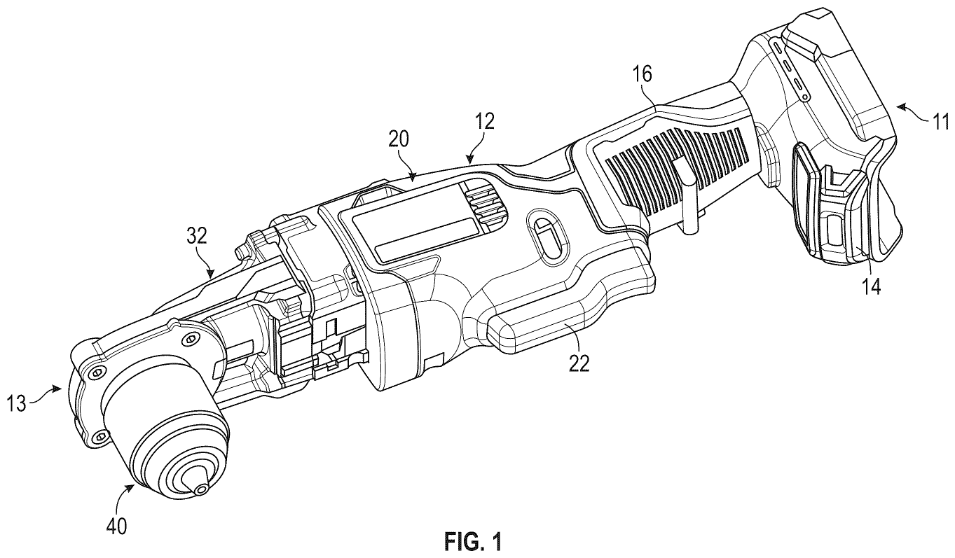

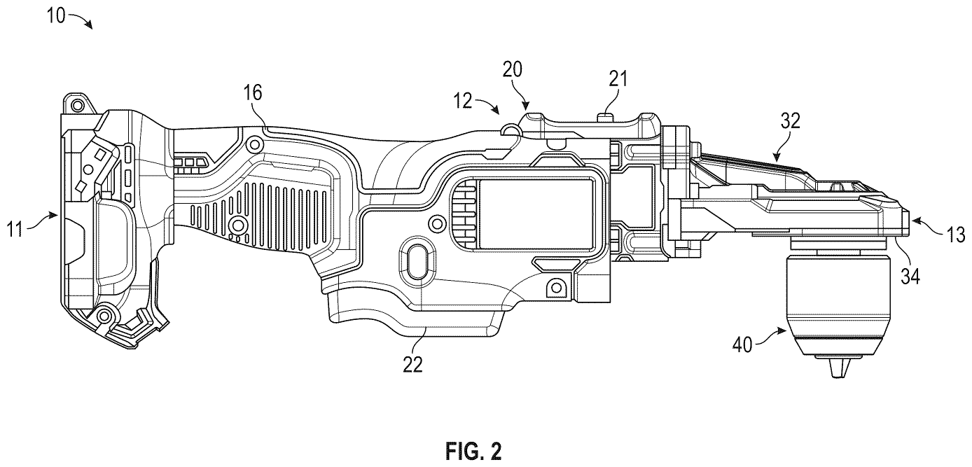

FIGS. 1 and 2 of the drawings show several views of a power tool 10 according to the present disclosure. The power tool 10 can either be corded (e.g., AC powered) or cordless (e.g., DC powered/battery operated). In the embodiments shown, the power tool 10 is a right angle drill, but the power tool 10 can be part of a set of power tools that can have features in common with the power tool 10 (for example, a battery pack interface thereof, such that components and features of the power tool 10 or those configured for use therewith may be interchangeably used with other power tools in the set).

In the embodiments shown the power tool 10 has a proximal end 11 and a distal end 13 along which a tool housing 12 is at least partially disposed. The tool housing 12 can at least partially define a generally elongate handle portion 16, a motor housing portion 20 with a trigger assembly 22 extending distally from the handle portion 16, and a battery receptable 14 proximate the proximal end 11 of the power tool. The tool housing 12 can have a generally contoured shape around the handle portion 16 and transition into a more cylindrical shape at the motor housing portion 20. In some embodiments, the handle portion 16 can be configured and arranged that a user or operator can ergonomically grip/maneuver the power tool 10 and easily actuate the trigger assembly 22 using one or more fingers.

In some embodiments, the motor housing portion 20 can have one or more selector switches 21 on the top, sides, and/or bottom of the tool housing 12 which can be actuated by a user or operator to control various features of the power tool 10 such as tool output speed, forward/reverse directional selection, clutch torque level, hammer/driver modes, or other features. In the embodiments shown in FIG. 1 and FIG. 2, the selector switch 21 is slidably mounted in the motor housing portion 20 and translatable between two or more switching positions selected by manual switching inputs from a user or operator of the power tool 10.

The power tool 10 has a right angle gearcase 32 mounted distal of the housing 12, and a tool holder 40 coupled to the gearcase 32. The tool holder 40 shown in the figures herein is a keyless chuck, although other attachment methods such as blade mounts, anvils, output spindles, or similar such devices can be anticipated. The chuck can be conventional in nature and configured to hold implements such as a drill bit or a driving type of accessory (e.g., standard, crosshead-shaped, hexagonal, star-shaped, etc.).

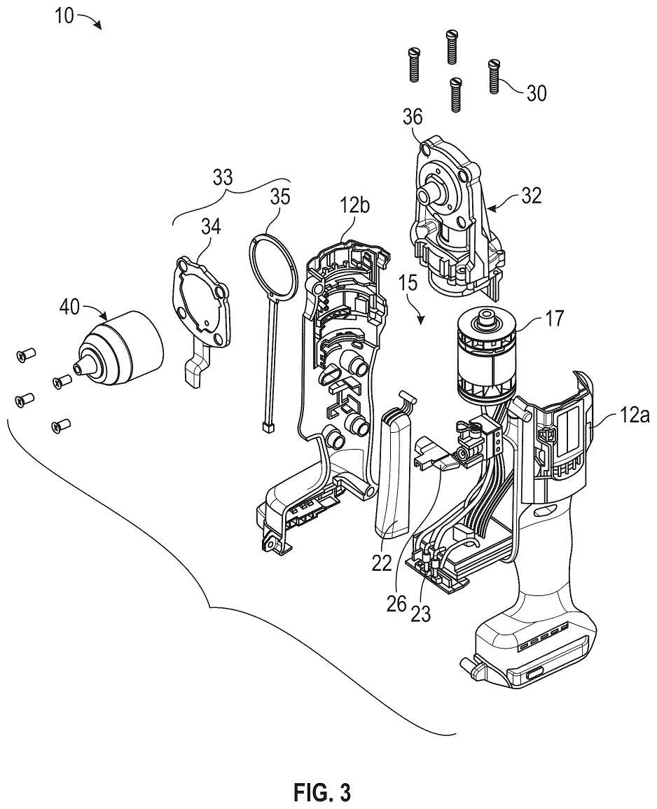

Referring to the exploded view in FIG. 3, the tool housing 12 of the power tool 10 can include a pair of clam shell halves or housing portions 12a, 12b that can cooperate to define the motor housing portion 20, handle portion 16, and battery receptacle 14. Viewed from the proximal end 11 of the power tool 10 (i.e., the user or operator's perspective), the tool housing 12 can include a left housing portion 12a and a right housing portion 12b that can mate generally along plane bisecting the power tool 10. In some embodiments, the clam shell halves 12a, 12b can be formed through injection molding a plastic material, e.g., an amorphous polymer (for example acrylonitrile butadiene styrene (ABS) or polycarbonate (PC)), a semi-crystalline polymer (for example, polypropylene (PP)), and/or a thermoplastic or related polymer (such as nylon polyamide (PA)).

The pair of housing portions 12a, 12b can at least partially surround an interior 15 of the tool housing within which one or more interior components of the power tool 10 can be held, as described further herein. In this regard, the tool housing 12 can have clamshell arrangement in which at least the left and right housing portions 12a, 12b are coupled to one another along a seam, though it will be understood that the tool housing 12 could be at least partially monolithically formed or assembled without departing from the disclosure.

When assembled, left housing portion 12a and right housing portion 12b can at least partially enclose a motor 17, a trigger assembly 22, a tool module 23, and a forward/reverse bar 26 in the interior 15 of the tool housing 12. The tool module 23 can include the electronics and control package for the power tool 10 including associated wiring and harnesses. In this regard, the tool module 23 can be configured as an electrical control module or a motor control module.

In some embodiments, the selectable or actuatable components of the power tool 10 such as the selector switch(es) 21 and trigger assembly 22 can extend radially outward from the interior 15 through openings or apertures in the housing 12 so as to be exposed for selective engagement during operation. The forward/reverse bar 26 can control a direction of rotation of the motor 17.

The battery receptacle 14 of the housing can have one or more openings or recesses for receiving a portable battery pack (not shown). The battery pack can supply electrical power to the motor 17 as well as other sensors, and components of the power tool 10. The battery pack can also supply power to control circuitry associated with the power tool 10 to effect various functions and processes thereof (e.g., actuation of the trigger mechanism 22, speed control, shifter selection, illumination capabilities, and/or other functions).

In some embodiments, the power tool 10 can be configured to accept battery packs of different sizes or voltages. For example, the power tool 10 can be configured to receive a battery pack with a maximum initial voltage of approximately 12 volts (V) unloaded, or a batter pack with a maximum initial voltage of approximately 20V unloaded. In other embodiments, another predetermined voltage potential, such as 3.67V, 3.3V, 14V, 8V, etc. can be utilized. The battery pack can include a plurality of cells composed, for example, of Li-ion, Lithium-ion-Phosphate, and/or another suitable cell chemistry.

It will be understood that that the battery receptacle 14 can be at least partially defined by a different arrangement of the housing 12. Furthermore, it will be understood that other power tools in a set of power tools can include a battery receptacle located in a different relative location depending on the use cases of the tool. For example, a power tool in the configuration of a saw, having a housing configuration different than that of a drill, could have a receptacle closer to the handle.

The gearcase 32 can be bolted or otherwise coupled to the tool housing 12 using one or more gearcase screws 30. In some embodiments, the gearcase 32 is constructed of aluminum or other suitable lightweight metals or metallic alloys, although other suitable structural materials can be used without departing from the disclosure.

In some embodiments, the power tool 10 can also be equipped with an illumination device 33 adjacent to or mated with the gearcase and configured to light an area or work surface in proximity of the tool holder 40 at the working end of the tool. The illumination device 33 includes a ring cover 34 and light ring 35 located behind the tool holder 40.

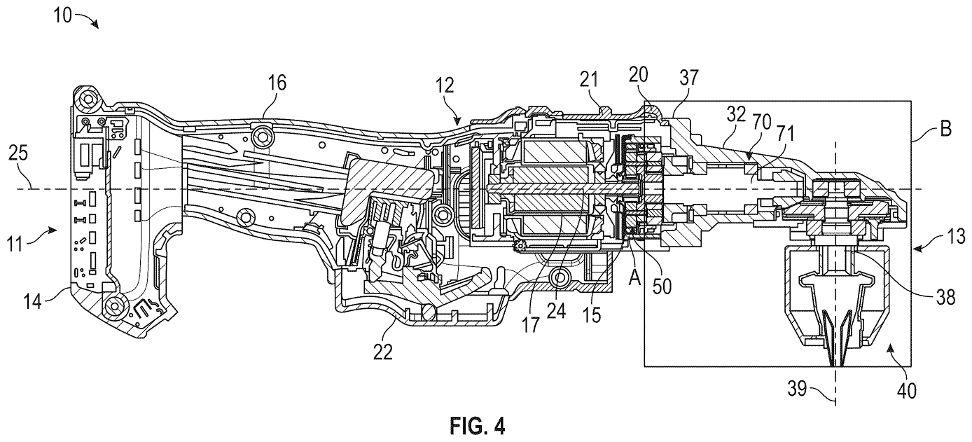

In some embodiments, the gearcase 32 can taper or otherwise have a distally-convergent configuration. In the embodiments shown, the gearcase 32 forms a generally wedge-shaped profile that transitions from a maximum radial size at a proximal flange 37 (see FIG. 4) defining the interface with the motor housing portion 20 of the tool housing 12 to approach a minimum size approximately adjacent to the tool holder 40 at the working end of the power tool 10. This shape of the gearcase 32 gives the power tool 10 improved accessibility to tight or cramped workspaces.

FIG. 4 is a side view of a cross-section of the power tool 10. The motor 17 disposed in the interior 15 of the tool housing 12 (e.g., an interior of the motor housing portion 20). The motor 17 can be energized to rotate a motor shaft or rotor shaft 24 about a motor axis 25 of the power tool 10. Broadly, the motor axis 25 can be considered a longitudinal axis, a first axis, and/or an input axis of the power tool 10. A transmission assembly 50 can be at least partially received in the motor housing portion 20 of the tool housing 12 axially forward of the motor 17 along the motor axis 25. In this sense, axially forward along the motor axis 25 refers to a direction on the motor axis 25 distally towards the gearcase 32 and/or the distal end 13 of the power tool 10. Axially rearward along the motor axis 25 can refer to a direction on the motor axis 25 proximally toward the motor 17.

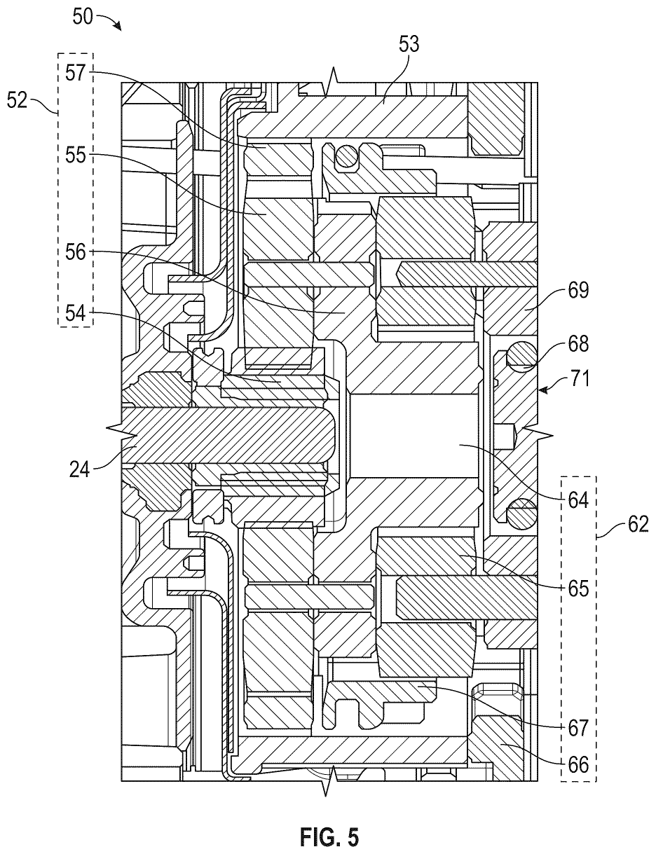

Referring additionally to FIG. 5, focused on the detail area ‘A’ identified in FIG. 4, the transmission assembly 50 can be substantially located in the interior 15 of the tool housing 12 and coupled with the rotor shaft 24 to transmit rotary power between the motor 17 and a pinion assembly 70 rotatable therewith about the motor axis 25. The pinion assembly 70 can have a pinion shaft 71 operatively coupled to the tool holder 40 through an output shaft 38 rotatable about a output axis 39 that is generally transverse to the motor axis 25. For example, when the power tool 10 is in a level orientation and held by a user, the motor axis 25 can generally extend toward and away from a user holding the power tool 10, and the output axis 39 can extend generally downwardly toward a floor or supporting surface. In some embodiments, the axes 25, 39 can be otherwise arranged relative to one another.

The transmission assembly 50 can have one or more reduction gearsets to decrease the output speed (and increase the output torque) of the motor 17 so the power tool 10 can drill a variety of hole sizes or drive a variety of fastener sizes/types. In the embodiments illustrated in FIG. 4 and FIG. 5, the transmission assembly 50 has two planetary gearsets 52, 62 with a speed change mechanism 53. The speed change mechanism 53 can be actuated to translate one or more movable components of the transmission assembly 50 by, for example, adjusting the selector switch 21 of the power tool 10.

The first planetary gear set 52 of the transmission assembly 50 can be coaxially arranged with the motor 17 and rotor shaft 24. The first planetary gear set 52 can be an input planetary stage including a first sun gear 54 mechanically coupled to, and rotatably driven by, the rotor shaft 24 to rotate about the motor axis 25. The first planetary gearset 52 can also include a plurality of first planet gears 55 intermeshed with and orbiting around the first sun gear 54. The plurality of first planet gears 55 can be coupled to a first planet carrier 56 and intermeshed with interior-facing teeth of a first ring gear 57 surrounding the plurality of first planet gears 55. The first planetary gearset 52 can produce a first reduction stage for the transmission assembly 50, wherein the first planet carrier 56 rotates about the motor axis 25 at some speed less than the speed of the rotor shaft 24.

Similarly, the transmission assembly 50 can further have a second planetary gear set 62 axially forward of the first planetary gearset 52. In this sense, axially forward along the motor axis 25 refers to a direction on the motor axis 25 distally towards the gearcase 32 and/or the distal end 13 of the power tool 10.

The second planetary gear set 62 can be an output planetary stage. The second planetary gearset 62 is driven by, and may be coaxial with, the rotor shaft 24 and the first planetary gearset 52. The second planetary gearset 62 includes a second sun gear 64 rotatably coupled with the first planet carrier 56 to rotate about the motor axis 25. The second planetary gearset 62 can also have a plurality of second planet gears 65 intermeshed with and orbiting around the second sun gear 64. The plurality of second planet gears 65 are rotatably supported by a second planet carrier 66 rotating about the motor axis 25 and can be surrounded by and intermeshed with the interior-facing teeth of the first ring gear 57 (or a second ring gear 67 that is non-rotatably coupled to the motor housing portion 20). The second planetary gearset 62 can produce a second reduction stage for the transmission assembly 50, wherein the second planet carrier 66 rotates about the motor axis 25 at some speed less than the speed of the first planet carrier 56.

As such, during the operation of the power tool 10, an initial drive torque is transmitted about the motor axis 25 via the rotor shaft 24 of the motor 17 to the first sun gear 54, causing the first sun gear 54 of the first planetary gearset 52 to rotate. The first planetary gearset 52 rotates in common with the first sun gear 54 about the motor axis 25, and a resulting first intermediate torque is applied to the second sun gear 64 of the second planetary gearset 62 by the first planet carrier 56. The rotation of the second planetary gearset 62 about the second sun gear 64 produces a second intermediate torque to be transmitted from the second planet carrier 66 to the pinion shaft 71 of the pinion assembly 70. In this fashion, the initial drive torque from the motor 17 is multiplied (and the initial drive speed reduced) in a predetermined manner according to the gear reduction ratio of the transmission assembly 50.

Although the example transmission assemblies shown have two planetary gearsets, the present disclosure has applicability to other types of transmissions as well. For example, in some embodiments, the transmission can be a two-speed transmission whereby the selector switch 21 allows a selective decoupling of one of the planetary stages by allowing one of the ring gears to spin freely. In other embodiments, the transmission could also include a lesser or greater number of planetary gearsets (e.g., the pinion shaft 71 could be coupled for rotation with the first planet carrier 56 of the first planetary gearset 52). In still other embodiments, the transmission assembly 50 may have or be configured for mechanical cooperation with a clutch mechanism configured to resist rotation of one or more components of the transmission.

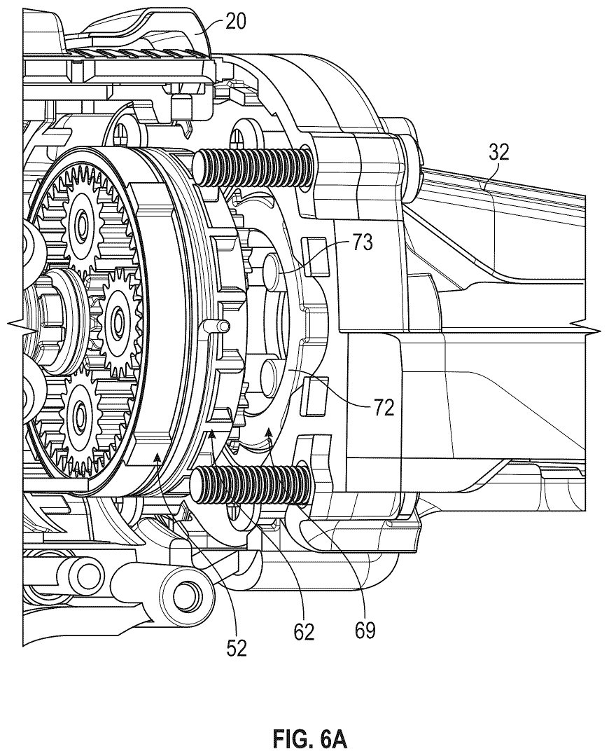

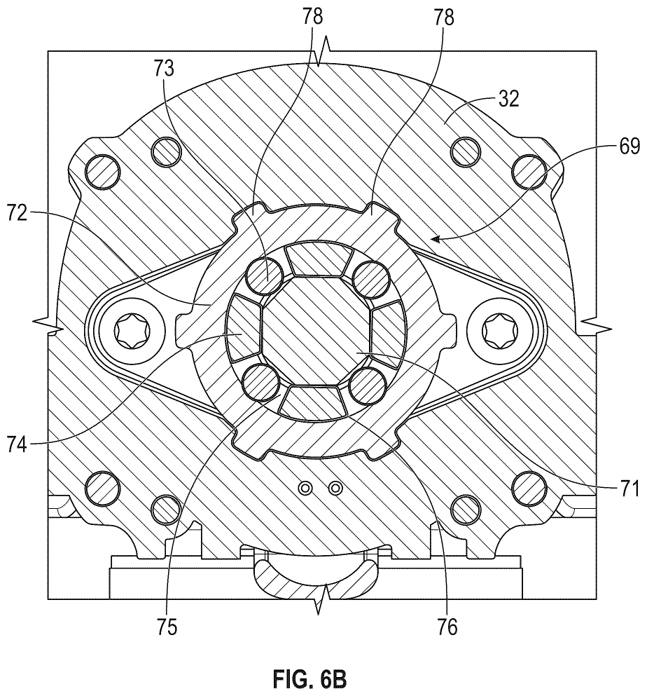

The pinion shaft 71 of the pinion assembly 70 can have a body with a proximal portion 68 that is non-rotatably coupled to the second planet carrier 66 for rotation therewith. In some embodiments, as shown in FIGS. 6A and 6B, the transmission assembly 50 can also include an automatic spindle lock assembly 69 disposed between the pinion shaft 71 and the second planet carrier 66. FIG. 6A shows an angled side view of the power tool 10 with the right housing portion 12b removed to show the transmission assembly 50 and the spindle lock assembly 69, where select components, such as the pinion shaft 71, are omitted for clarity. FIG. 6B shows the spindle lock assembly 69 looking axially forward (i.e., distally) from the transmission assembly 50 along the motor axis 25.

The spindle lock assembly 69 can include an outer collar 72, a plurality of lock pins 73, a plurality of projections 74 that can be mated with or integrally formed with the body of the second planet carrier 66, and an anvil 75. The outer collar 72 can be a generally annular structure that has a plurality of features 78 (e.g., legs, ridges, splines, or other suitable geometries) which can be received in a recess or against a shoulder of the gearcase 32 so as to be non-rotatably engaged therewith. The lock pins 73 can extend longitudinally parallel with the motor axis 25 and between the projections 74 and an inner surface 76 of the outer collar 72. The anvil 75 can be mounted on a proximal portion 68 of the pinion shaft 71 such that the anvil 75 is rotatably coupled with the pinion shaft 71 for rotation therewith. The spindle lock assembly 69 can be configured for permitting the second planet carrier 66 to drive the pinion shaft 71 in a given direction, but inhibiting rotation of the pinion shaft 71 that would tend to drive the second planet carrier 66.

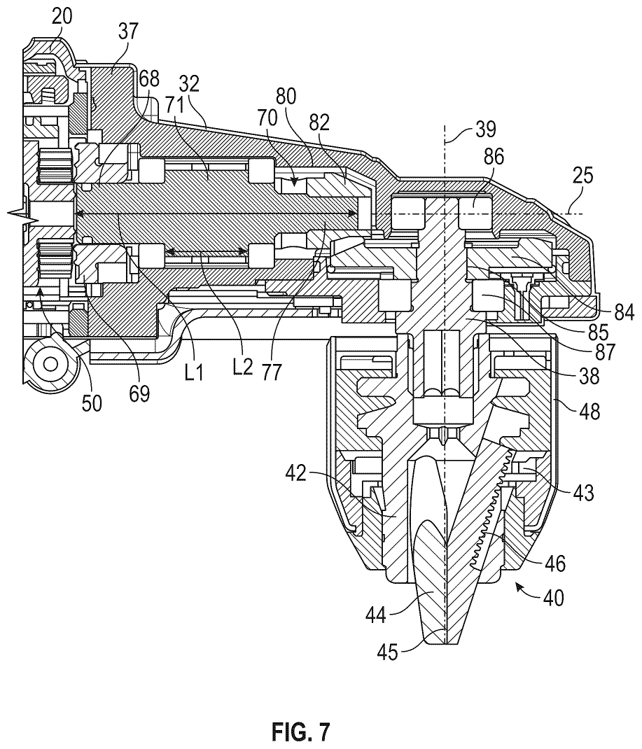

Referring to FIGS. 7-10, FIG. 7 shows detail area ‘B’ identified in FIG. 4. The gearcase 32 of the power tool 10 can have a hollow or semi-hollow gearcase chamber 80 at least partially receiving the pinion assembly 70. FIG. 7 shows an enlarged view of detail B from FIG. 4. The pinion shaft 71 can have a length L1 parallel to the motor axis 25 that extends nearly the entire horizontal length of the gearcase 32 so that the transmission assembly 50 may be housed proximally (e.g., fully or almost fully within the motor housing portion 20), allowing the gearcase 32 to be more compact. In some embodiments, the length L1 of the pinion shaft can be in a range between and including approximately 50 mm and approximately 60 mm. In another embodiment, the length L1 of the pinion shaft can be approximately 55 mm.

In some embodiments, the pinion assembly 70 can be located entirely in the gearcase chamber 80 of the gearcase 32. In other embodiments, at least part of the proximal portion 68 of the pinion shaft 71 can be located in the motor housing portion 20 of the tool housing 12, and the pinion shaft 71 is supported for rotation by one or more elements of the transmission assembly 50, e.g., the second sun gear 64, the second planet carrier 66, the spindle lock assembly 69, or other elements.

The pinion shaft 71 can operatively couple the transmission assembly 50 to the output shaft 38 such that the output shaft 38 and at least a portion of the tool holder 40 can rotate about the output axis 39 when the motor 17 is energized. Torque can be transmitted to the output shaft 38 by a first gear 82 rotatably coupled to a distal portion 77 of the pinion shaft 71 for rotation therewith about the motor axis 25. In some embodiments, the first gear 82 can be coupled to the pinion shaft 71 and/or may at least partially receive a portion of pinion shaft 71 in an internal bore therethrough (e.g., the first gear 82 can be press fit on the pinion shaft 71). In other embodiments, the first gear 82 can be monolithically formed with the pinion shaft 71 (e.g., machined together as a single member).

The first gear 82 can be intermeshed with a second gear 84 operatively coupled with the output shaft 38 for rotation therewith about the output axis 39. The motor axis 25 can be transverse or at a right angle (e.g., substantially perpendicular) to the output axis 39, such that the first gear 82 and the second gear 84 are configured and arranged to transmit torque from the rotor shaft 24 driven by the motor 17 from the motor axis 25 to further downstream components of the tool holder 40 along the output axis 39. In other embodiments, the output axis 39 may be at an angle less than or greater than 90 degrees to the motor axis 25.

In some embodiments, the gear ratio between the first gear 82 and the second gear 84 may be different than 1:1, e.g., such that the second gear 84 has a greater or lesser number of teeth than the first gear 82 and such that the second gear 84 rotates at a slower or faster speed than the first gear 82. In some embodiments, the gear ratio between the first gear 82 and the second gear 84 may be at least 2:1. In some embodiments, the gear ratio between the first gear 82 and the second gear 84 may be approximately 3.56:1.

In some embodiments, the selector switch 21 is operatively coupled to the speed change mechanism 53. In this way, the selector switch 21 can slidably translatable in the motor housing portion 20 and between two or more switching positions corresponding to differing tool rotational output speeds. In some embodiments, the power tool can have a reduction ratio such that the output speed is approximately 1600 RPM when the selector switch 21 is in a first position. In some embodiments, the power tool can have a reduction ratio such that the output speed is approximately 550 RPM when the selector switch 21 is in a second position.

As a result of the foregoing arrangement, the first gear 82 and the second gear 84 may change the direction along which rotational motion is transmitted while also providing the mechanical advantage of an increase in torque so as to produce an additional reduction stage for the transmission assembly 50. In some embodiments, the first gear 82 and second gear 84 are intermeshed bevel gears, e.g., a first or input bevel gear and a second or output bevel gear. The bevel gears may have straight cut or helical teeth. In other embodiments, the first gear 82 and second gear 84 may have a worm gear arrangement so as to have the form of a worm gear and a worm wheel. It will be understood that a different configuration of the first gear 82 and second gear 84 may be provided without departing from the disclosure.

The tool holder 40 can be coupled to the output shaft 38 for rotation therewith. For example, the tool holder 40 can be threadably engaged with one end of the output shaft 38, or alternatively the tool holder 40 can use a tapered arbor or bore for engaging the output shaft 38. In the example embodiment shown in FIG. 7, the power tool 10 is a right angle drill and/or driver where the tool holder 40 is a chuck configured for releasably retaining the shank of a tool bit, such as a drill bit or a driving type of accessory (e.g., standard, crosshead-shaped, hexagonal, star-shaped, etc.). The chuck can be conventional in nature, such as, for example, the self-locking keyless chuck for a hand held power tool as shown and described herein. Although a keyless chuck is illustrated, it will be appreciated that the drill may also utilize other chucks (e.g., a quick-release chuck, a keyed chuck, a hybrid chuck, etc.).

The chuck can have chuck body 42 attached to the output shaft 38 and configured so that rotation of the body in one direction relative to a constrained nut 43 engages a plurality of jaw members 44 to grip and clamp the shank of the tool bit. Rotation of the chuck body 42 in the opposite direction can release the gripped relationship between the plurality of jaw members 44 and the shank of the tool bit.

In some embodiments, the chuck body 42 is rotatable with an outer sleeve or collar 48 about the output axis 39, whereby the jaw members 44 are advanced or retracted. The nut 43 can be, for example, press fit within the collar 48 or, alternatively, a two-piece nut or drive lug can form an engaged relationship between the nut 43 and the collar 48. The collar 48 can form an annular sleeve or hood around at least a portion of the chuck body 42. The collar 48 can be generally cylindrical with one or more outer circumferential surfaces that are contoured, molded, ribbed, knurled, or otherwise textured such the collar 48 can be securely gripped to selectively hold the chuck body 42 stationary through the grasping of this surface.

The plurality of jaw members 44 can be slidably positioned in oblique or angularly disposed passageways in the chuck body 42. The plurality of jaw members 44 can be angled with respect to the output axis 39 but intersect the output axis 39 at a common point. Each jaw member 44 can have a tool engaging edge 45 and opposing threads 46 on an outer surface. In some embodiments, three jaw members 44 can be spaced approximately 120 degrees apart in an annular arrangement around an axial bore within the chuck body 42. A greater or lesser number of jaw members 44 for the chuck can also be contemplated without departing from the disclosure.

In some embodiments, the tool engaging edges 45 of the jaw members 44 can be substantially parallel with the output axis 39. The space between the tool engaging edges 45 can define an axial bore coincident with the output axis 39 and into which the shank of a tool bit can be received. The axial bore can be configured such that is has a diameter, when the jaw members 44 are fully open, that is slightly larger than the diameter of the largest tool shank the chuck is designed to accommodate.

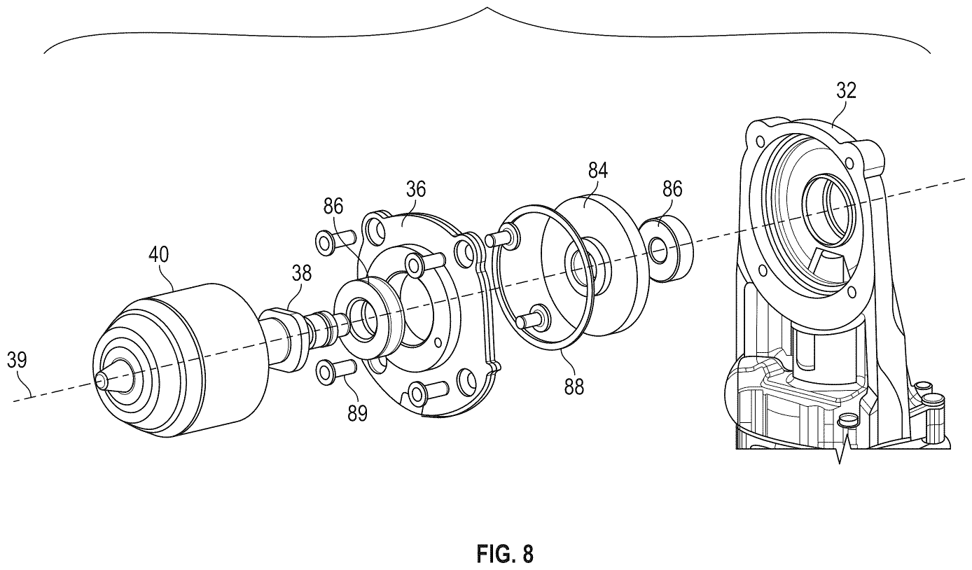

Referring further to FIG. 7 and the exploded view shown in FIG. 8, the output shaft 38 may extend along the output axis 39 through a portion of the vertical length of the gearcase 32, through a central bore 85 in the second gear 84, and at least partially into an interior space of the tool holder 40. A gearcase cover 36 can be fixed to the gearcase 32 using fasteners 89 or other suitable implements such that the second gear 84 and a cover seal 88 are secured within the gearcase 32.

A plurality of bearings may be provided to support the axial alignment of the output shaft 38 along the output axis 39 to balance the rotation of the output shaft 38 as well as to support a sufficient stiffness and resistance to deformation for facilitating implementations of the power tool 10. The plurality of bearings may be located or journalled inside the gearcase 32 (e.g., press fit or otherwise fixed within a recess or shoulder) with the second gear 84 behind the gearcase cover 36, and each bearing may receive a respective portion of the output shaft 38 at least partially therethrough.

In the illustrated embodiment, a rear output shaft bearing 86 can be disposed along the output axis 39 and having an annular configuration so as to at receive a portion of the output shaft 38 therethrough, such that at least a portion of the output shaft 38 and rear output shaft bearing 86 are axially rearward of the motor axis 25 along the output axis 39. As described herein, axially rearward refers to a direction along the output axis 39 away from the tool holder 40. The rear output shaft bearing 86 may be, for example, a ball bearing configured to transmit rearward and/or forward thrust loads from the output shaft 38 into the gearcase 32 while minimizing, inhibiting, and/or preventing friction against the rotating output shaft 38 extending therethrough.

A front output shaft bearing 87 can be disposed in a portion of the gearcase 32 along the output axis 39 at a location axially forward of the motor axis 25. In this sense, axially forward along the output axis 39 refers to a direction on the output axis 39 closer to the tool holder 40 such that the front output shaft bearing 87 is positioned vertically below the second gear 84. The front output shaft bearing 87 may receive at least a portion of the output shaft 38 therein. The front output shaft bearing 87 may be, for example, a ball bearing, a journal bearing, or a bushing configured to support the output shaft 38 and the second gear 84 while minimizing, inhibiting, and/or preventing friction against the rotating output shaft 38 extending therethrough.

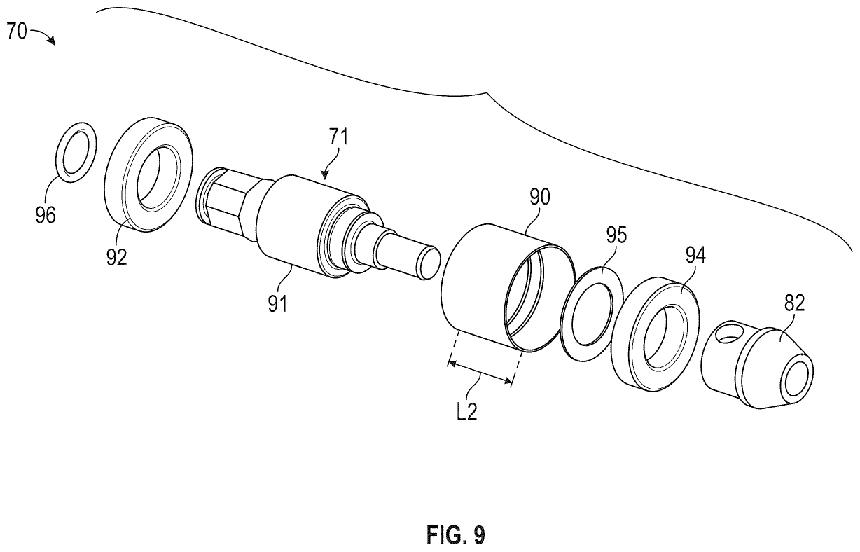

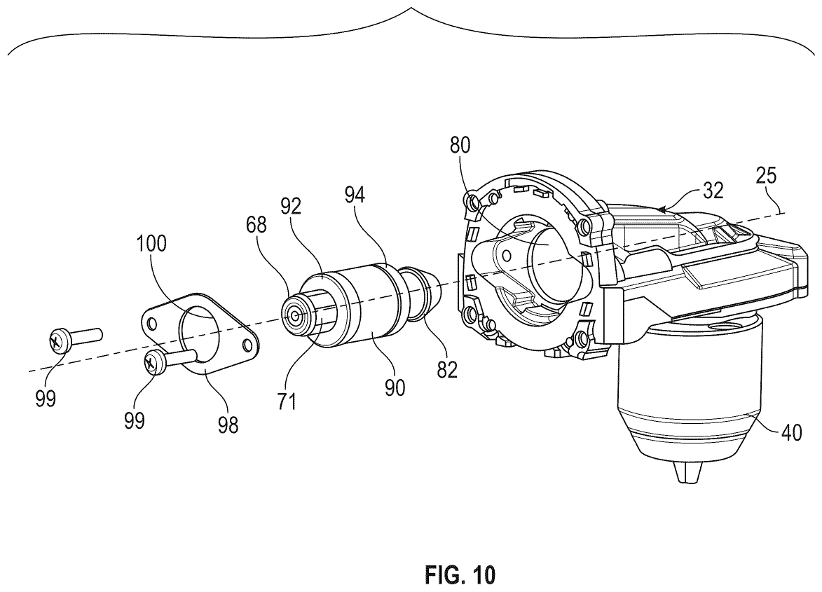

With further reference to FIGS. 9 and 10, the pinion shaft 71 of the pinion assembly 70 can have a stepped configuration extending along the majority of the horizonal length of the gearcase 32 and having the first gear 82 rotatably coupled to the front portion or distal end thereof for rotation about the motor axis 25. An annular spacer 90 can be located on a central portion 91 of the pinion shaft 71 and at least partially received in a correspondingly sized recess in the gearcase chamber 80 of the gearcase 32 so as to be radially nested in between the pinion shaft 71 and a portion of the interior wall of the gearcase 32. The front portion of the stepped pinion shaft 71 can have a first diameter and the rear portion of the pinion shaft can have a second diameter greater than the first diameter.

The pinion shaft 71 can be supported by two or more bearings located or journalled inside the gearcase 32 adjacent to and on opposing sides of the spacer 90 and the central portion 91. In the examples illustrated, a rear pinion bearing 92 can be disposed in a portion of the gearcase 32 along the motor axis 25 at a location between the transmission assembly 50 and the spacer 90, and a front pinion bearing 94 can be disposed along the motor axis 25 axially forward of the rear pinion bearing 92 between the spacer 90 and the first gear 82. In this sense, axially forward along the motor axis 25 refers to a direction on the motor axis 25 pointing towards the gearcase and/or distal end 13 of the power tool 10 and axially rearward refers to a direction on the motor axis 25 pointing toward the motor 17 and/or proximal end 11 of the power tool 10. The rear pinion bearing 92 and front pinion bearing 94 can be, for example, ball bearings configured to transmit axially rearward thrust loads from the output shaft 38 of the power tool 10 into the transmission assembly 50.

As disclosed herein, the length L1 of the pinion shaft allows the gearcase 32 to have a tapered, lower profile for accessibility. The use of two spaced bearings (the rear pinion bearing 92 and front pinion bearing 94) can balance and facilitate free rotation of the pinion shaft 71 and transmit the thrust loads generated by the first gear 82 and the second gear 84 as the power tool 10 is operated under load. The spacer 90 can be radially sized to have a diameter such that the generated thrust loads are transmitted between the outer races of the pinion bearings 92, 94 and the gearcase 32. The spacing between the pinion bearings 92, 94 can also impart sufficient stiffness to the pinion assembly 70 to support the stepped pinion shaft 71 over transitions from a larger diameter to a smaller diameter, and to maintain the alignment of the longer pinion shaft in support of critical dimensions of the power tool 10 (e.g., the bearings can constrain the first gear 82 so as to tightly control the critical distances between the first gear 82 and the second gear 84).

For example, in some embodiments, the spacer 90 can have an axial length L2 separating the rear pinion bearing 92 and front pinion bearing 94 and parallel to the motor axis 25 that is between and including approximately 10 mm and approximately 22 mm, between and including approximately 12 mm and approximately 20 mm, between and including approximately 14 mm and about 18 mm, etc., and integer and non-integer values therebetween.

Although two pinion bearings are shown in the examples herein, a lesser or greater number of bearings can be used to support rotation of the pinion shaft. The bearings can also be disposed differently, or be of a different type (e.g., journal, needle, roller, bushing, etc.) without departing from the disclosure.

In some embodiments, the pinion assembly 70 can also include a front sealing element 95 and a rear sealing element 96 positioned on opposing sides of the pinion shaft 71. The front sealing element 95 and rear sealing element 96 can prevent grease and/or contaminants (e.g., from the first gear 82/second gear 84 and the transmission assembly 50) from reaching the central portion 91 of the pinion shaft 71.

With continued reference to FIG. 10, the pinion assembly 70 can be received in the gearcase chamber 80 of the gearcase 32 and fixed axially in place with a retaining plate 98. The retaining plate 98 can be fixedly attached to the gearcase using retention screws 99 or other suitable mechanical fasteners. In some embodiments, the entirety of the length of the pinion shaft 71 is located in the gearcase chamber 80 of the gearcase 32 (i.e., axially forward of the tool housing 12 along the motor axis 25). In other embodiments, at least a portion of the length of the pinion shaft 71 can extend proximally of the interface between the gearcase 32 and the motor housing portion 20. The proximal portion 68 of the pinion shaft 71 can protrude axially rearward along the motor axis 25 through an opening 100 in the retaining plate 98 for engagement with one or more of the spindle lock assembly 69 (see, e.g., FIG. 6B, where the plurality of projections 74 can be formed integrally with the body of the second planet carrier 66). The retaining plate 98 thus permits rotation of the pinion shaft 71 about the motor axis 25 but prevents relative axial or radial translation thereof.

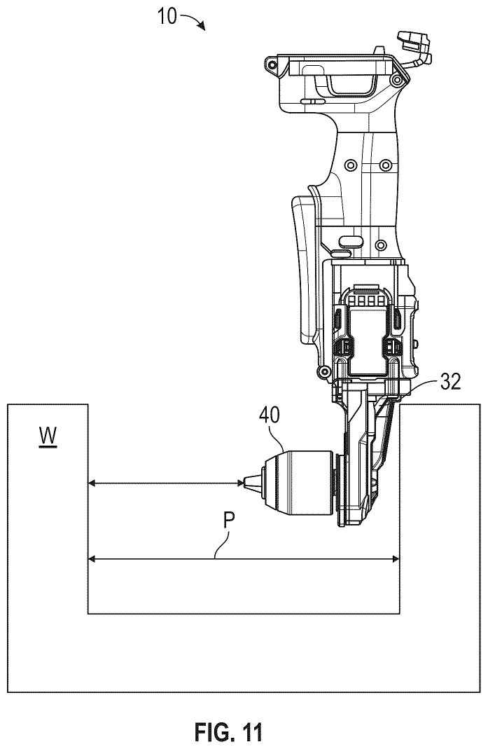

As disclosed herein, the length of the pinion shaft 71 allows the height or vertical size of the gearcase 32 to be advantageously reduced without increasing the overall length of the power tool 10. The corresponding shape of the gearcase 32 can thus taper to a minimum size approximately adjacent to the tool holder 40 at the working end (approximate the distal end 13) of the power tool 10. As shown schematically in FIG. 11, this reduced shape and size of the gearcase 32 gives the power tool 10 improved accessibility and maneuverability in a tight or cramped workspace having a work surface W with a narrow opening P or otherwise constrained geometry. In the case of the right-angle drill shown in the example, the low-profile of the gearcase 32 also gives the power tool 10 the ability to be used with longer bits or drive fasteners of a greater length within the opening P.

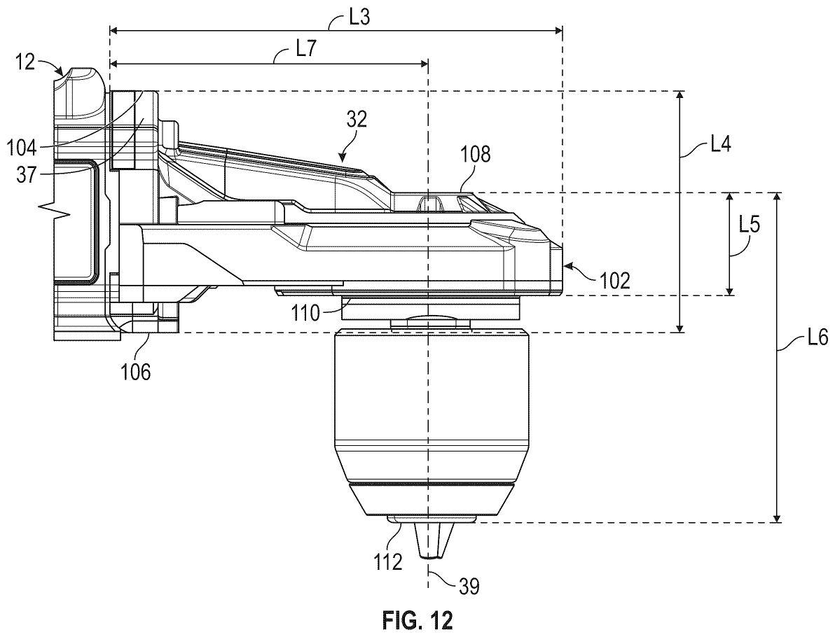

FIG. 12 illustrates further dimensional aspects related to the low-profile gearcase 32 of the described power tool 10 according to embodiments of the disclosure. The example is shown with the gearcase 32 attached to the tool holder 40 (e.g., the tool chuck) as together these assemblies will geometrically control accessibility to tight spaces proximate the distal end 13 portion of the power tool 10.

The power tool 10 can have a length L3 defined as the horizontal distance parallel to the motor axis 25 between the proximal end of the gearcase 32 (the interface seam where the gearcase 32 is mated to the tool housing at proximal flange 37) and the distal end 102 of the gearcase 32. In some embodiments, L3 is in a range between and including approximately 90 mm and approximately 100 mm. In some embodiments, L3 is approximately 95 mm.

The power tool 10 can have a length L4 defined as the vertical distance parallel to the output axis 25 between an upper surface 104 and a lower surface 106 of the proximal flange 37 at the proximal end of the gearcase 32 (the height or width of the gearcase 32 where the gearcase 32 is mated to the tool housing 12 at proximal flange 37). In some embodiments, L4 is in a range between and including approximately 40 mm and approximately 60 mm. In some embodiments, L4 is in a range between and including approximately 45 mm and approximately 55 mm. In some embodiments, L4 is approximately 51 mm.

The power tool 10 can have a length L5 defined as the vertical distance parallel to the output axis 39 between an upper surface or top end 108 and a lower surface or bottom end 110 of the gearcase 32 at the output axis 39 (the height or width of the gearcase 32 at the output axis 39 or in a plane passing through the output axis 39). In some embodiments, L5 is in a range between and including approximately 20 mm and approximately 30 mm. In some embodiments, L5 less than or equal to approximately 35 mm. In some embodiments, L5 less than or equal to approximately 30 mm. In some embodiments, L5 is approximately 25 mm.

The power tool 10 can have a length L6 defined as the vertical distance parallel to the output axis 39 between the upper surface or top end 108 of the gearcase 32 in a plane passing through the output axis 39 and a lower surface or bottom end 112 of the tool holder 40. In some embodiments, L6 is in a range between and including approximately 65 mm and approximately 90 mm. In some embodiments, L6 is in a range between and including approximately 70 mm and approximately 80 mm, including integer and non-integer values therebetween. In some embodiments, L6 is approximately 75 mm.

The power tool 10 can have a length L7 defined as the horizontal distance parallel to parallel to the motor axis 25 between the proximal end of the gearcase 32 (the interface seam where the gearcase 32 is mated to the tool housing at proximal flange 37) and the output axis 39. In some embodiments, L7 is in a range between and including approximately 60 mm and approximately 80 mm. In some embodiments, L7 is in a range between and including approximately 65 mm and approximately 75 mm, including integer and non-integer values therebetween. In some embodiments, L7 is between approximately 68 mm and approximately 69 mm, for example, approximately 68.6 mm.

The compact size of the gearcase 32 allows the power tool 10, in some embodiments, to have a ratio of the distance L6 to the distance L5 in a range between and including approximately 2.5 and approximately 3.5. In some embodiments, the ratio of the distance L6 to the distance L5 is approximately 3.0.

The compact size of the gearcase 32 can also allow the power tool 10, in some embodiments, to have a slenderness ratio of the distance L4 to the distance L3 in a range between and including approximately 0.40 and approximately 0.67. In some embodiments, the slenderness ratio of the distance L4 to the distance L3 is approximately 0.54.

The compact size of the gearcase 32 can further allow the power tool 10, in some embodiments, to have a slenderness ratio of the distance L7 to the distance L4 in a range between and including approximately 1.0 and approximately 2.0. In some embodiments, the slenderness ratio of the distance L7 to the distance L4 is approximately 1.4.

The foregoing power tool 10 described herein may thus be activated by a user or operator to perform a variety of rotary operations on a work surface, such as drilling holes with bits and/or saws, buff surfaces with abrasive and/or polishing media, and drive fasteners, to name but a few. In some embodiments, the work surface W can have a narrow opening P as illustrated in FIG. 11, and the some or all of the gearcase 32 of the power tool 10 may be introduced into the opening P and advanced toward work surface W to perform the desired operations.

In this regard, and with reference again to FIGS. 1-12, the user or operator may grasp the tool housing 12, and actuate the trigger assembly 22 to activate the motor 17. For example, pressing an end or portion of the trigger assembly 22 may cause an electric circuit to close, may actuate a controller associated with one or more field effect transistors (FETs), etc., to cause electrical power to be supplied from a battery pack or another power source to the motor 17.

Depending on the geometry of the work surface W or the leverage required to perform the desired operations, the user or operator may grip the power tool 10 in different positions. For example, referring again to FIGS. 1 and 2, the power tool 10 may have a forward grip position where, for example, the palm of the user or operator's operative hand is centered on the top or side of the gearcase 32 axially forward of the trigger assembly 22 and the switch assembly is actuated by one or more of the pinky finger or ring finger. When using the forward grip position, the user or operator can optionally place their non-operative hand on the handle portion 16 for support. The power tool 10 may also have a rear grip position where, for example, a user or operator's operative hand is centered on the handle portion 16 of the tool housing 12 located axially rearward of the trigger assembly 22 and the trigger assembly 22 is actuated by one or more fingers, e.g., the index and middle finger. As described herein, axially forward along the motor axis 25 refers to a direction on the motor axis 25 pointing towards the gearcase and/or distal end 13 of the power tool 10 and axially rearward refers to a direction on the motor axis 25 pointing toward the motor 17 and/or proximal end 11 of the power tool 10.

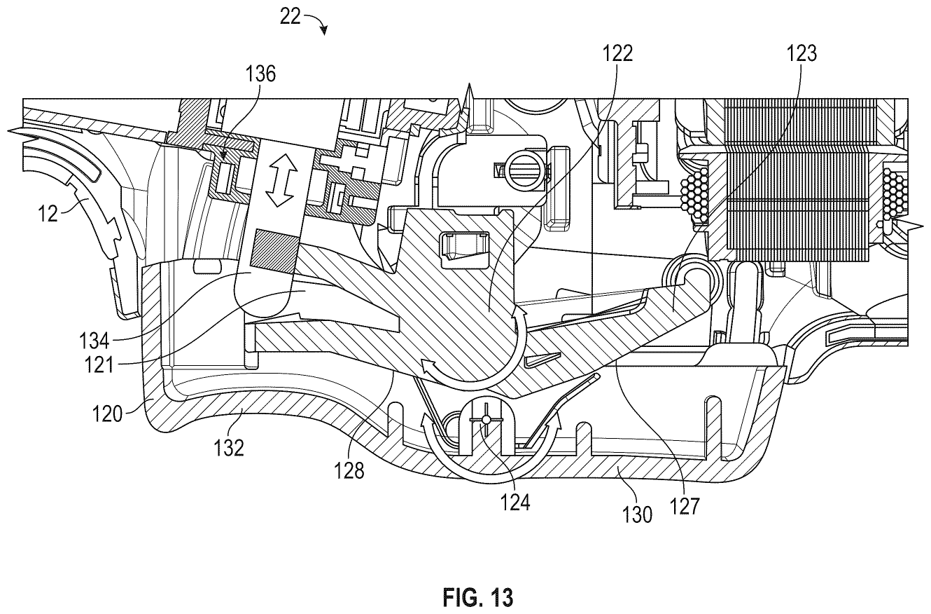

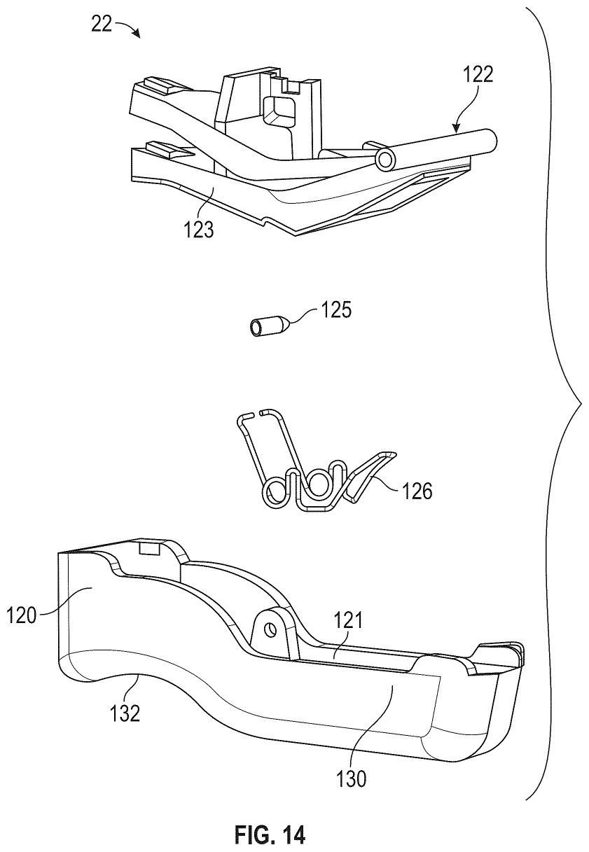

In some embodiments, the trigger assembly 22 can be a paddle-type switch that is secured to the tool housing 12 via one or more pivots. Referring to FIGS. 13 and 14, FIG. 13 illustrates an example trigger assembly 22 in cross-section. FIG. 14 shows an exploded view of select components of the example trigger assembly 22.

The trigger assembly 22 can include an outer member 120 and an inner member 122 that are fixed at and rotatable about a central pivot 124. The outer member 120 can have an arcuate outer surface that can be contoured for ergonomic use, e.g., with sections that are concave and/or convex towards the tool housing 12. The outer member 120 can further have a first portion 130 axially forward of the central pivot 124 and a second portion 132 axially rearward of the central pivot 124. As such, pressure applied to the first portion 130 by a user or operator will tend to rotate the outer member 120 counterclockwise (from the perspective of FIG. 13) about the central pivot 124. Similarly, pressure applied to the second portion 132 by a user or operator will tend to rotate the outer member 120 clockwise (from the perspective of FIG. 13) about the central pivot 124.

The outer member 120 can also have a hollow or semi-hollow interior 121 into which the inner member 122 can be at least partially received. The inner member 122 can have a follower assembly 123 that reacts with rotation of the outer member 120 at a first bearing surface 127 when pressure is applied to the first portion 130 axially forward of the central pivot 124, and a second bearing surface 128 that reacts with rotation of the outer member 120 when pressure is applied to the second portion 132 axially rearward of the central pivot 124.

The central pivot 124 can have a pin 125 axially fixed within the tool housing 12 about which the outer member 120 and the inner member 122 can pivot together. A return spring 126 can be rotatably coupled to the pin 125 at the central pivot 124. The return spring 126 can be biased to resist rotation (clockwise or counterclockwise) of the outer member 120 and inner member 122 about the central pivot 124 and return the trigger assembly 22 to a nominal position (i.e., neutral or resting) when the user or operator is not actuating the trigger assembly 122.

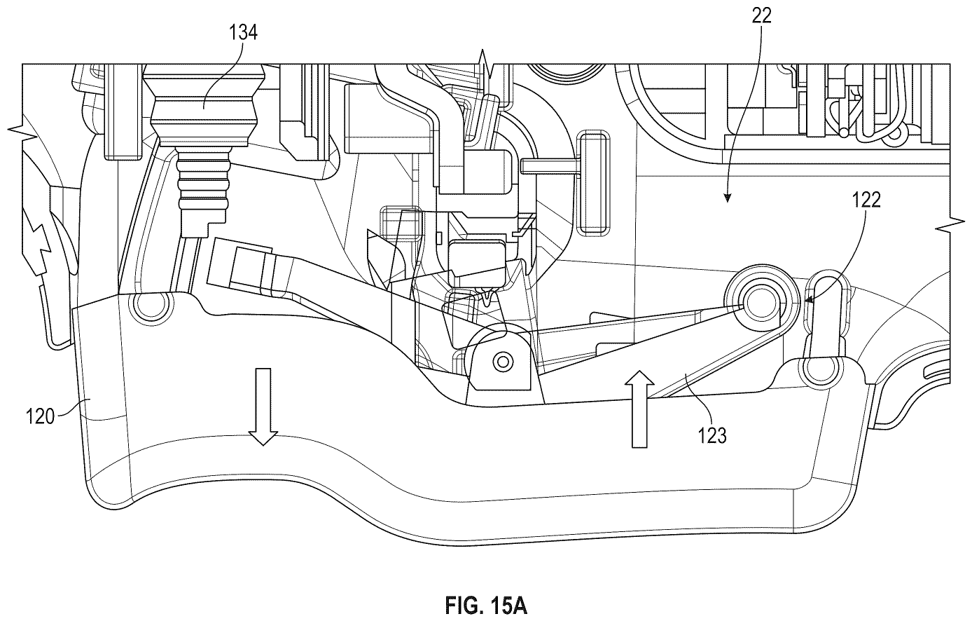

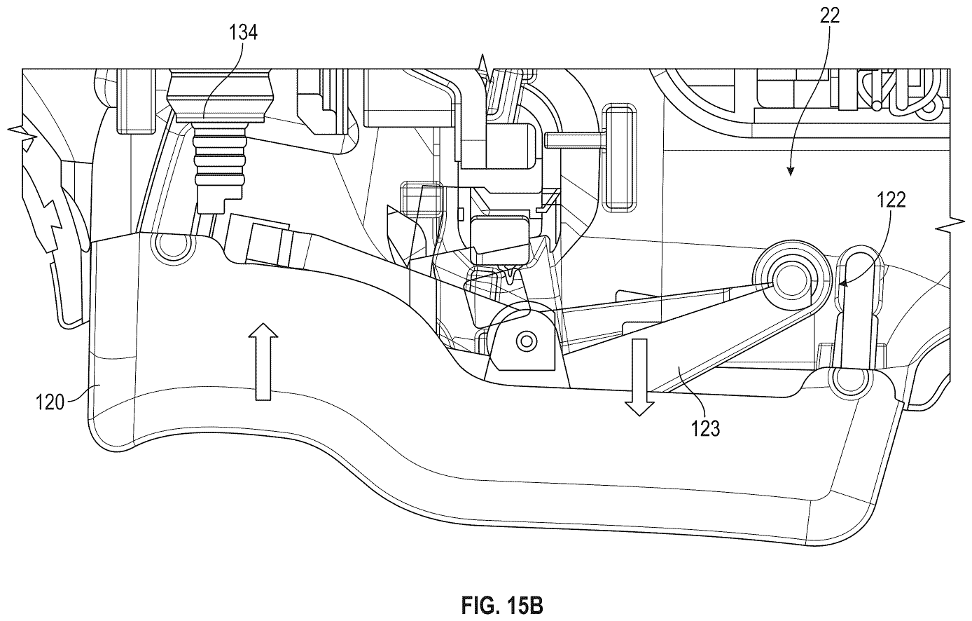

Referring to FIGS. 15A and 15B, the trigger assembly 22 thus pivots with the tool housing 12 such that the follower assembly 123 of the inner member 122 activates a plunger 134 of an energizing switch assembly 136 fixed within the tool housing 12 and electrically coupled to the motor 17. The plunger 134 of the switch assembly 136 can be configured to energize the motor 17 when the trigger assembly 22 is rotated either clockwise or counterclockwise about the central pivot 124. Thus, when pressure is applied by a user or operator to the first portion 130 of the outer member 120 (see arrows in FIG. 15A), the trigger assembly 22 is rotated counterclockwise about the central pivot 124 and the outer member 120 will push against the follower assembly 123 of the inner member 122 at the first bearing surface 127 to activate the plunger 134. Similarly, when pressure is applied by a user or operator to the second portion 132 of the outer member 120 (see arrows in FIG. 15B), the trigger assembly 22 is rotated clockwise about the central pivot 124 and the outer member 120 will push against the follower assembly 123 of the inner member 122 at the second bearing surface 128 to activate the plunger 134. The central pivot 124 therefore functions as a dual pivot where pressure applied to either side of the pivot point can cause the switch assembly 136 to energize the motor 17.

Upon energization of the motor 17, a torque may be applied by the rotor shaft 24 through the transmission assembly 50 and pinion assembly 70 to the first gear 82, resulting in the first gear 82 rotating about the motor axis 25. The second gear 84 intermeshed with the first gear 82 is thus driven to rotate about the output axis 39. The output shaft 38, being rotatably coupled with the second gear 84, thus rotates therewith about the output axis 39.

In some embodiments, the trigger assembly 22 can also be provided with an optional quick release feature, in which disengagement of the switch assembly 22 by the user or operator results in substantially immediate deactivation of the motor 17.

Due to the paddle-style, centrally-pivotable arrangement of the trigger assembly 22, multiple points therealong (e.g., forward of or rearward of the pivot point) are presented for the user or operator to activate the power tool 10 having similar actuation forces and tactile feedback, such that the trigger assembly 22 can easily and ergonomically operated regardless of whether the user or operator's operative hand is in the forward grip position or the rearward grip position. The disclosed trigger assembly 22 can thus provide the power tool 10 with flexibility and enhanced versatility in operation, especially in working environments in which space is restricted.

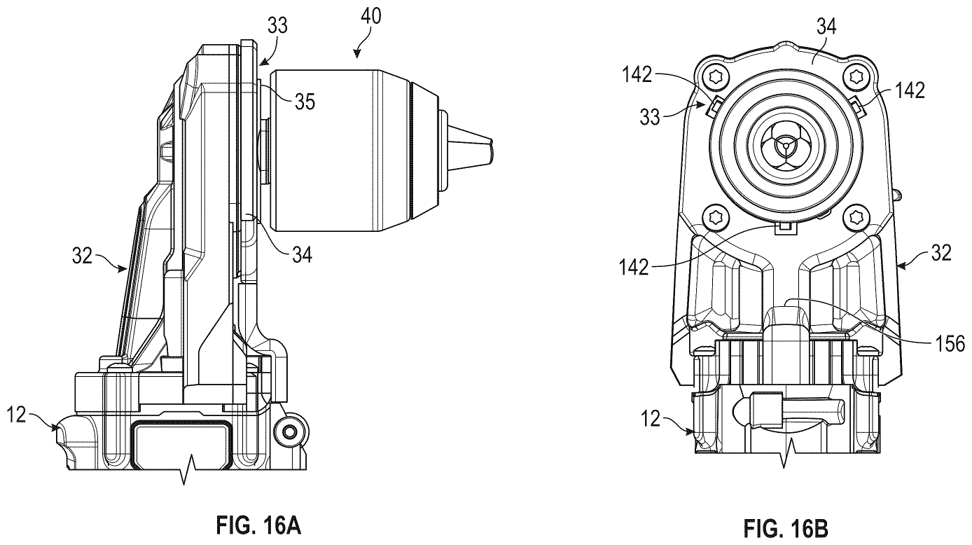

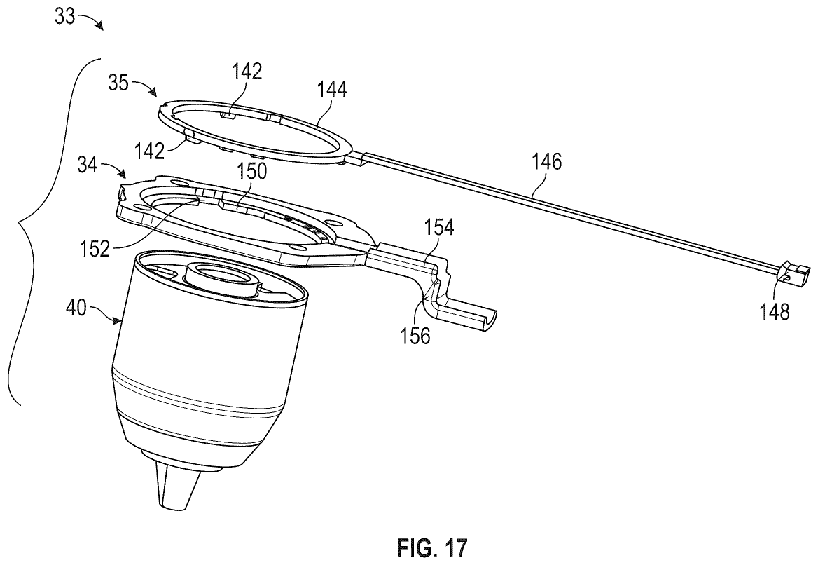

Referring again to FIG. 3 and with further reference to FIGS. 16A, 16B, 17, and 18, the illumination device 33 of the power tool 10 can be arranged, for example, such that the ring cover 34 and the light ring 35 are affixed to the gearcase cover 36 of the gearcase 32 axially rearward of the tool holder 40 along the output axis 39. In some embodiments, the gearcase cover 36 can have a flat, recessed, or beveled surface for receiving and locating the ring cover 34 and light ring 35. In other embodiments, the gearcase cover 36 can have one or more flanges, trenches, or anchoring features for receiving and locating the ring cover 34 and light ring 35.

As part of the illumination device 33, light emitting diodes or LEDs 142 can be located at various points around the light ring 35. In some embodiments, the LEDs 142 emit white light, although other colors or a combination of colors could also be emitted. FIG. 16B shows three LEDs spaced about 120 degrees apart on the light ring 35, although any number of LEDs can be used without departing from the disclosure.

The LEDs 142 can be mounted to a substantially circular printed circuit board (PCB) 144 with wires 146 attached to and extending elongate from a rear portion of the PCB 144. The wires 146 can terminate at a plug 148 approximate the proximal end of the light ring 35. The plug 148 can be made from a more rigid material than the wires 146 to securely hold the wire ends. In some embodiments, the plug 148 can be, for example, an electrical connector such as a crimp or wiring harness that serves as a joint whereby the wires 146 can be electrically coupled to the battery pack or other power source of the power tool 10.

The ring cover 34 can protect interior components of the illumination device 33 and the power tool 10 from moisture or other contaminants. The ring cover 34 can have a recessed face 150 configured to receive the PCB 144 therein, with one or more exposure elements 152 circumferentially aligned with the LEDs 142. The exposure elements 152 can are thus directly over the LEDs 142 and permit light generated by the LEDs to pass through the ring cover 34. In some embodiments, the exposure elements 152 are rectangular cutouts shaped to correspond with the shape of the LEDs 142. In other embodiments, the exposure elements 152 are molded as translucent or clear elements that simply allow the generated light to pass through. In further embodiments, the exposure elements 152 may focus, direct, and/or change the color of the generated light.

The wires 146 can be fit into a groove or trench 154 in a wire way 156 extending proximally from the ring cover 34 and along the gearcase 32 to the tool housing 12. The wire way 156 can provide a routing for the wires 146 to deliver the plug 148 to the tool housing 12, while also adding protection and structural strength to prevent undue mechanical loads from being placed on the PCB 144 and wires 146.

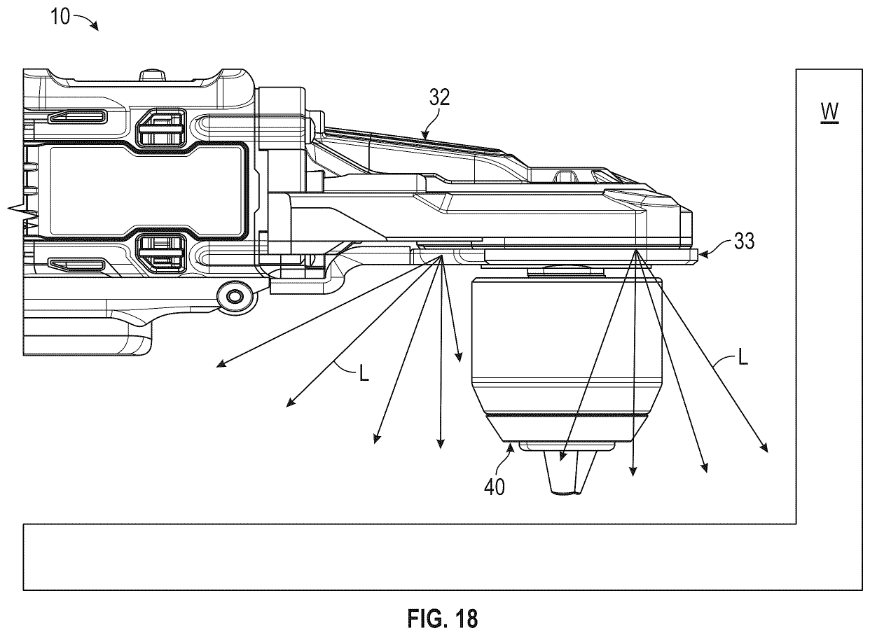

As shown in FIG. 18, the low-profile gearcase 32 as disclosed herein is advantageous for providing a mounting point for the LEDs 142 of the illumination device 33 in a generally circular arrangement behind and coaxial with the tool holder 40. The illumination device 33 of the power tool 10 can emit light L in all directions around the tool holder 40 so that the user or operator can see the end of the power tool 10 and the work surface W. This configuration of the illumination device 33 can be especially useful in a tight or cramped workspace that may not have access to natural light, or in situations where light may be at least partially blocked by the tool holder 40.

In view of the foregoing, power tools as set forth above and described herein are provided with a gearcase having a reduced size and shape that provides such power tools improved accessibility and maneuverability in a tight or cramped workspaces. Additionally or alternatively, power tools disclosed herein are provided with trigger assemblies with multiple modalities of actuation to provide for enhanced dexterity and operation. Additionally or alternatively, power tools disclosed herein are provided with an illumination device with a robust arrangement and positioned for enhanced visibility in working environments.

The foregoing description of the disclosure illustrates and describes various exemplary embodiments. Various additions, modifications, changes, etc., could be made to the exemplary embodiments without departing from the spirit and scope of the disclosure. Example embodiments have been provided so that this disclosure will be thorough, and to fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

The terms “distal” and “proximal” are used throughout the preceding description and are meant to refer to a positions and directions relative to a user. As such, “distal” or distally” refer to a position distant to or a direction away from the user. Similarly, “proximal” or “proximally” refer to a position near or a direction towards the user.

When an element or layer is referred to as being “on,” “engaged to,” “connected to,” or “coupled to” another element or layer, it may be directly on, engaged, connected, or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings of the example embodiments.

Terms of degree such as “generally,” “substantially,” “approximately,” and “about” may be used herein when describing the relative positions, sizes, dimensions, or values of various elements, components, regions, layers and/or sections. These terms mean that such relative positions, sizes, dimensions, or values are within the defined range or comparison (e.g., equal, or close to equal) with sufficient precision as would be understood by one of ordinary skill in the art in the context of the various elements, components, regions, layers and/or sections being described.

What is claimed is:

1. A power tool, comprising:
a tool housing extending at least partially around an interior of the tool housing;
a motor at least partially received in the interior of the tool housing;
a rotor shaft extending from the motor along a motor axis of the power tool such that the motor is configured to apply a first torque to the rotor shaft;
a transmission assembly comprising at least one planetary gearset mechanically coupled to the rotor shaft for producing a gear reduction on the rotor shaft at the first torque;
a pinion assembly comprising a pinion shaft mechanically coupled to the at least one planetary gearset for rotation about the motor axis, the pinion shaft receiving a second torque from the at least one planetary gearset when the motor is activated such that the second torque is greater than the first torque;
a gearcase coupled to the tool housing, the gearcase extending at least partially around a gearcase chamber;
an output shaft at least partially received in the gearcase chamber, the output shaft arranged for being driven by the pinion shaft along an output axis, the output axis perpendicular to the motor axis; and
a tool holder at least partially receiving the output shaft,
wherein the pinion shaft has a length along the motor axis between approximately 50 mm and approximately 60 mm.

2. The power tool of claim 1, wherein the pinion assembly further comprises a pinion bearing mounted to a front portion of the pinion shaft and radially positioned between a portion of the gearcase and a portion of the pinion shaft.

3. The power tool of claim 2, wherein the pinion shaft is oriented along the motor axis such that an axially rearward direction is toward the motor and such that an axially forward direction is toward the gearcase, wherein the pinion bearing is a front pinion bearing, and wherein the pinion assembly further comprises a rear pinion bearing mounted to the pinion shaft radially between the gearcase and the pinion shaft, the rear pinion bearing disposed axially rearward of the front pinion bearing along the motor axis.

4. The power tool of claim 3, the pinion assembly further comprising a spacer radially positioned between the pinion shaft and the gearcase, the spacer arranged between the front pinion bearing and the rear pinion bearing along the motor axis.

5. The power tool of claim 4, wherein the front pinion bearing, the rear pinion bearing, and the spacer are positioned in the gearcase chamber axially forward of the tool housing along the motor axis.

6. The power tool of claim 4, the pinion assembly further comprising a bevel gear in mechanical communication with the pinion shaft and positioned axially forward of the front pinion bearing along the motor axis, the bevel gear intermeshed with an output gear mechanically coupled to the output shaft.

7. The power tool of claim 1, wherein the at least one planetary gearset is arranged to form a central bore at least partially receiving a portion of the pinion shaft therethrough.

8. The power tool of claim 7, wherein the at least one planetary gearset comprises a sun gear mechanically coupled to the rotor shaft, a plurality of planet gears intermeshed with the sun gear, the plurality of planet gears coupled to a planet carrier, and a ring gear surrounding and intermeshed with the plurality of planet gears.

9. The power tool of claim 8, wherein the pinion shaft is coupled to the planet carrier for rotation therewith.

10. The power tool of claim 8, wherein the pinion shaft is oriented along the motor axis such that an axially rearward direction is toward the motor and such that an axially forward direction is toward the gearcase, and wherein at least the sun gear, the plurality of planet gears, and the ring gear are axially rearward of the gearcase.

11. The power tool of claim 8, the transmission assembly further comprising a spindle lock assembly, wherein the spindle lock assembly is configured to permit the pinion shaft to be rotatably driven by the transmission assembly and inhibit rotation of the pinion shaft when the pinion shaft is rotated manually.

12. The power tool of claim 8, wherein the at least one planetary gearset is a first planetary gearset, the sun gear is a first sun gear, the plurality of planet gears are a plurality of first planet gears, the ring gear is a first ring gear, and the planet carrier is a first planet carrier, and the transmission assembly further comprises a second planetary gearset mechanically coupled to the first planetary gearset, the second planetary gearset comprising a second sun gear, a plurality of second planet gears intermeshed with the second sun gear, a second planet carrier coupled to the plurality of second planet gears, and a second ring gear surrounding and intermeshed with the plurality of second planet gears.

13. The power tool of claim 12, wherein the pinion shaft is mechanically coupled to the second planet carrier for rotation therewith.

14. The power tool of claim 1, wherein the pinion shaft has a front portion with a first diameter and a rear portion with a second diameter greater than the first diameter.

15. The power tool of claim 1, wherein the pinion shaft has a length along the motor axis of approximately 55 mm.

16. The power tool of claim 1, wherein the gearcase has a top end, a bottom end, and a height along the output axis from the top end to the bottom end that is less than approximately 35 mm.

17. The power tool of claim 16, wherein the height of the gearcase is approximately 26 mm.

18. The power tool of claim 1, further comprising a trigger assembly for energizing the motor and comprising an inner member at least partially received in an outer member, the outer member and inner member fixed and rotatable about a central pivot.

19. The power tool of claim 18, wherein the trigger assembly is engageable at a first portion of the outer member and a second portion of the outer member to pivot the trigger assembly about the central pivot and energize the motor.

20. The power tool of claim 1, further comprising an illumination device mounted to the gearcase and coaxially arranged with the tool holder.

21. The power tool of claim 20, wherein the illumination device comprises a ring cover supporting a plurality of light emitting diodes (LEDs).
